(19) United States
(12) Patent Application Publication
(10) Pub. No.: US 2002/0152656 A1
(43) Pub. Date: Oct. 24, 2002

(54) Decorative lamp simulating the effect of an aquarium

(76) Inventor: Line-Yao Huang, Changhua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/840,163

(22) Filed: Apr. 24, 2001

(51) Int. Cl. G09F 13/00

(52) U.S. Cl. 40/431

(57) ABSTRACT

A decorative lamp includes a base holding a lamp bulb and a motor drive unit, a rotary table supported on the base around the lamp bulb and rotated by the motor drive unit, an inner lampshade fixedly mounted on the rotary table for synchronous rotation with the rotary table, the inner lamp shade having a design of underwater scene on an outside wall thereof, and a magnifying transparent outer lampshade fixedly mounted on the base and covering over the inner lampshade to magnify the dimensions of the inner lampshade.

### BACKGROUND OF THE INVENTION

The present invention relates to a lamp and, more particularly, to a decorative lamp, which simulates the effect of an aquarium.

An aquarium-simulating lamp is known, as shown in FIGS. 1 and 2, comprised of a base 10, a rotary table 16, an inner lampshade 19, an intermediate lampshade 20, and an outer transparent lampshade 22. The base 10 comprises a top coupling groove 101. A motor (not shown) is mounted inside the base 10. A lamp bulb 11 is provided at the top side of the base 10. A pinion 12 is fixedly mounted on the output shaft M of the motor and disposed above the top sidewall of the base 10. Transmission gears 13,14,15 are provided in the base 10 and meshed with one another and driven to rotate by the pinion 12. The inner lampshade 19 admits light, having a design of water animals, water waves and spindrift on the outside wall thereof and a bottom coupling groove 190. The rotary table 16 is fixedly mounted in the bottom coupling groove 190 of the inner lampshade 19 and revolvably secured to the base 10 with a locating ring 18 by screws, comprising a plurality of hooks 160, and a driven gear 17 meshed with the transmission gear 14. When starting the motor, the inner lampshade 19 is rotated with the rotary table 16 in clockwise direction on the base 10. The intermediate lampshade 20 admits light and is mounted on the base 10 around the inner lampshade 19, having a design of underwater scene on the outside wall thereof and a bottom inner gear 21 meshed with the transmission gear 13 for counter-clockwise rotation on the base 10 relative to the inner lampshade 30. The transparent outer lampshade 22 is fastened to the base 10 and covered over the intermediate lampshade 20 and the inner lampshade 19, having a plurality of bottom hooks 220 respectively hooked on the top coupling groove 101 of the base 10. When starting the motor, the inner lampshade 19 and the outer lampshade 20 are rotated relative to each other in reversed directions, to show a motion, simulating the effect of an aquarium. This structure of aquarium-simulating lamp has numerous drawbacks as outlined hereinafter:

1. The transparent outer lampshade 22 is a simple covering that does not enlarge the image of the inner lampshade 19 and the outer lampshade 20 to produce a three-dimensional visual effect.

2. Because two rotary lampshades (the inner lampshade and the intermediate lampshade) are provided, the structure of the aquarium-simulating lamp is complicated, and much electric energy is consumed when rotating the two rotary lampshades in the reversed directions.

3. Because the aquarium-simulating lamp does not have image enlarging function, it is less attractive.

### SUMMARY OF THE INVENTION

It is one object of the present invention to provide a decorative lamp, which simulates the visual effect of an aquarium. It is another object of the present invention to provide an aquarium-simulating decorative lamp, which has a simple structure. It is still another object of the present invention to provide an aquarium-simulating decorative lamp, which provides a magnified motion visual effect. According to one aspect of the present invention, the decorative lamp comprises a base holding a lamp bulb and a motor drive unit, a rotary table supported on the base around the lamp bulb and rotated by the motor drive unit, an inner lampshade fixedly mounted on the rotary table for synchronous rotation with the rotary table, the inner lamp shade having a design of underwater scene on its outside wall, and a transparent outer lampshade fixedly mounted on the base and covering over the inner lampshade, the transparent outer lampshade having a design of underwater scene on its inside wall. According to another aspect of the present invention, the transparent outer lampshade is a magnifying lampshade having ribs on its outside wall to function as convex lens means for magnifying the dimensions of the inner lampshade.

### BRIEF DESCRIPTION OF THE DRAWINGS

FIG. 1 is an exploded view of an aquarium-simulating lamp according to the prior art.

FIG. 1A is a sectional view taken along line A-A of FIG. 1.

FIG. 2 is a sectional top view of the prior art aquarium-simulating lamp.

FIG. 3 is an exploded view of a decorative lamp according to the present invention.

FIG. 3A is a sectional view taken along line A-A of FIG. 3.

FIG. 4 is a sectional top view of the decorative lamp according to the present invention.

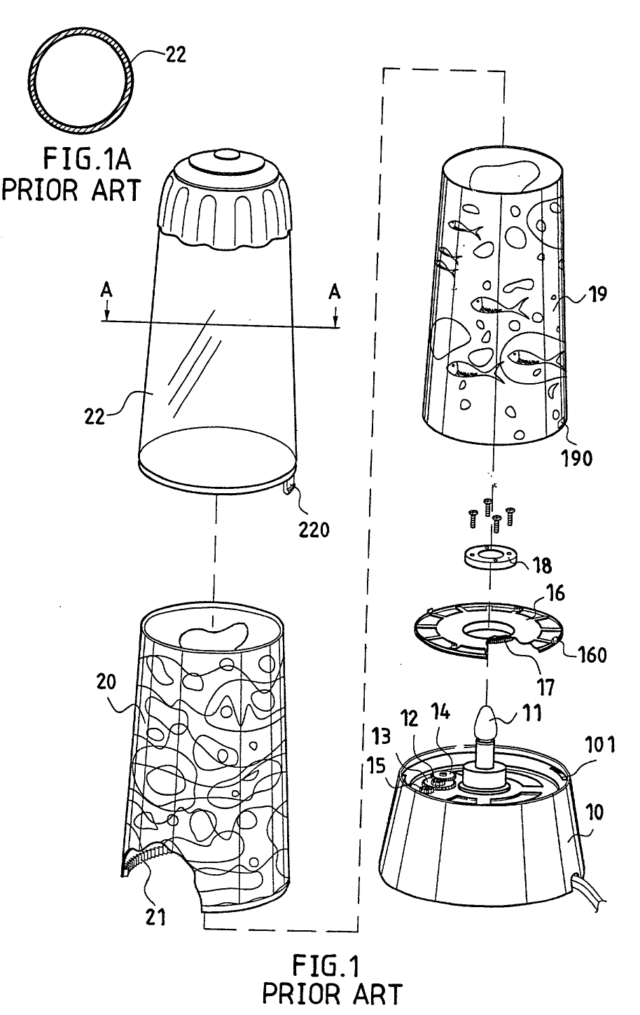

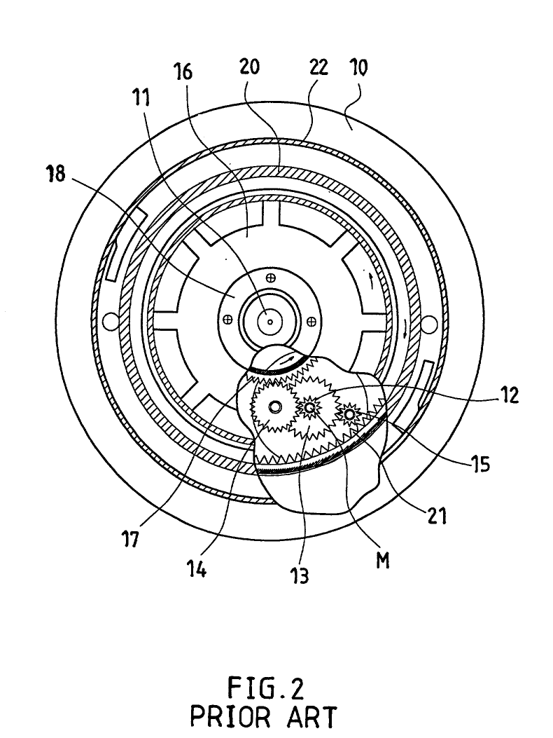

### DETAILED DESCRIPTION OF THE PREFERRED EMBODIMENT

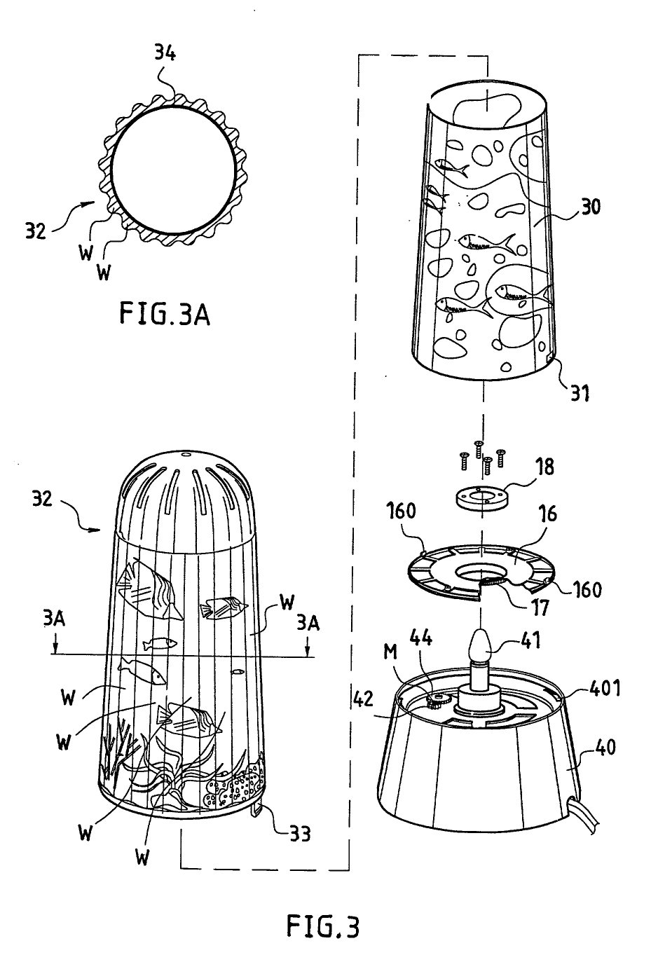

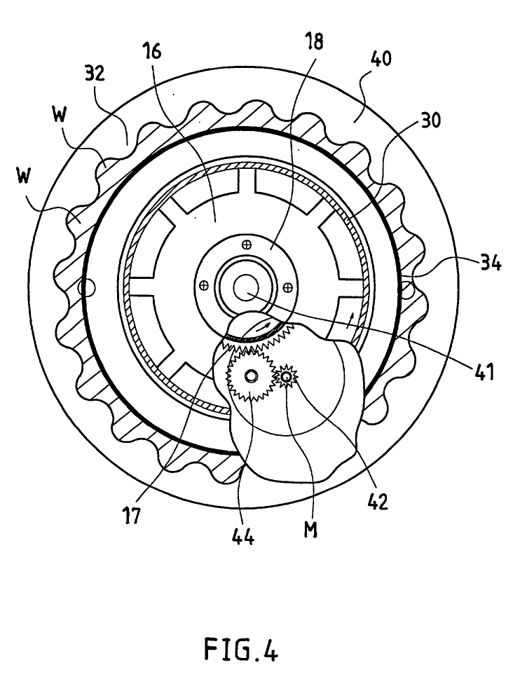

Referring to FIGS. 3 and 4, a decorative lamp in accordance with the present invention is shown comprising a base 40, a rotary table 16, an inner lampshade 30, and a magnifying outer lampshade 32. The base 40 comprises a top coupling groove 401. A lamp bulb 41 is provided at the top side of the base 40. A motor is mounted in the base 40 with the output shaft M extended out of the top sidewall of the base 40. A pinion 42 is fixedly mounted on the output shaft M of the motor. A transmission gear 44 is supported on the top sidewall of the base 40 and meshed with the pinion 42. The rotary table 16 is revolvably mounted on the top sidewall of the base 40 with a locating ring 18, having a plurality of top hooks 160, and a fixed bottom gear 17 meshed with the transmission gear 44. The inner lampshade 30 admits light and is fixedly mounted on the rotary table 16 for synchronous rotation with the rotary table 16, having a design of underwater scene on the outside wall thereof and a bottom coupling groove 31 hooked up with the top hooks 160 of the rotary table 16. The magnifying outer lampshade 32 is a transparent lampshade of magnifying glass fixedly mounted on the base 40 over the inner lampshade 30 to magnify the apparent dimensions of the inner lampshade 30, having a design of underwater scene on the inside wall thereof and a plurality of bottom hooks 33 respectively hooked in the top coupling groove 401 of the base 40. The outside wall of the magnifying outer lampshade 32 is not a smooth wall. As illustrated in FIG. 3A, the magnifying outer lampshade 32 has a plurality of ribs W on the outside wall 34, producing a convex lens effect to magnify the apparent dimensions of the inner lampshade 30.

Referring to FIG. 4 again, when electrically connected, the lamp bulb 41 is turned on to emit light through the inner lampshade 30 and the magnifying outer lampshade 32, and at the same time the pinion 42 is driven by the output shaft M of the motor to rotate the transmission gear 44 and then the bottom gear 17 of the rotary table 16, thereby causing the inner lampshade 30 to be rotated with the rotary table 16 on the base 40 inside the magnifying outer lampshade 32, producing a motion visual effect. Because the inner lampshade 30 is rotated inside the magnifying outer lampshade 32, the design of underwater scene of the inner lampshade 30 and the design of underwater scene of the magnifying outer lampshade 32 are turned relative to each other in reversed direction, simulating the visual effect of an aquarium.

A prototype of decorative lamp has been constructed with the features of FIGS. 3 and 4. The decorative lamp functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A decorative lamp comprising a base, a rotary table supported on said base, a lamp bulb installed in said base, a motor drive unit installed in said base and controlled to rotate said rotary table on said base, an inner lampshade fixedly mounted on said rotary table and covering over said lamp bulb for synchronous rotation with said rotary table, said inner lamp shade having a design of underwater scene on an outside wall thereof, and a transparent outer lampshade fixedly mounted on said base and covering over said inner lampshade, wherein said transparent outer lampshade has ribs on an outer sidewall thereof to function as convex lens means for magnifying the dimensions of said inner lampshade, and a design of underwater scene on an inside wall thereof.
